(19) United States
(12) Patent Application Publication
(10) Pub. No.: US 2007/0045070 A1
(43) Pub. Date: Mar. 1, 2007

(54) Disturbance isolation systems and methods for sensors

(75) Inventor: Nicolas D. Damien, Safety Harbor, FL (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 11/215,573

(22) Filed: Aug. 29, 2005

(51) Int. Cl. F16M 1/00

(52) U.S. Cl. 188/378; 267/136

(57) ABSTRACT

Systems and methods for disturbance isolation of small sensors is provided. A disturbance isolation bracket comprises a structural band having an inner surface and an outer surface, at least one isolating element coupled to the outer surface of the structural band, and at least one device mount coupled to the structural band and adapted to secure a sensor device to the structural band.

### GOVERNMENT LICENSE RIGHTS

The U.S. Government may have certain rights in the present invention as provided for by the terms of Contract No. DASG60-00-C-0072 awarded by the U.S. Department of the Army.

### TECHNICAL FIELD

The present invention generally relates to sensors and more particularly to isolation of sensors from shock and vibration.

### BACKGROUND

Small sensors are useful in aerospace applications because of their ruggedness and their low weight and volume. However, many aerospace applications, such as missiles and launch vehicles expose these small sensors to a high shock and vibration environment that may exceed the sensor's shock and vibration ratings. Because of their small size, it is difficult or impractical to employ conventional disturbance isolation systems for small sensors. This is because applying sufficient elastomer materials to reduce a small sensor's resonant frequency results in significantly increasing the physical volume which must be allotted to each sensor in the end application. Additionally, sensors such as accelerometers are typically mounted with an orthogonal orientation to each other. Individually applying a disturbance isolation system to each sensor degrades the overall performance of a navigation system due to the undesirable relative motion between the accelerometers under shock and vibration loading.

For the reasons stated above and for other reasons stated below which will become apparent to those skilled in the art upon reading and understanding the specification, there is a need in the art for improved disturbance isolation systems and methods for small sensors.

### SUMMARY

The Embodiments of the present invention provide methods and systems for disturbance isolation of sensors and will be understood by reading and studying the following specification.

In one embodiment, a disturbance isolation bracket is provided. The bracket comprises a structural band having an inner surface and an outer surface, at least one isolating element coupled to the outer surface of the structural band, and at least one device mount coupled to the structural band and adapted to secure a sensor device to the structural band.

In another embodiment, a sensor system is provided. The system comprises one or more sensor devices; a disturbance isolation bracket including a structural band having an inner surface and an outer surface, at least one isolating element coupled to the outer surface of the structural band, and one or more device mounts coupled to the structural band and adapted to secure the one or more sensor devices to the structural band; and a housing adapted to accommodate insertion of disturbance isolation bracket.

In yet another embodiment, a method for isolating sensors from disturbances is provided. The method comprises securing one or more sensor devices onto a disturbance isolation bracket comprising a structural band having an inner surface and an outer surface, the disturbance isolation bracket further comprising at least one isolating element coupled to the outer surface of the structural band; and inserting the disturbance isolation bracket into a housing.

In still another embodiment, a disturbance isolation bracket is provided. The bracket comprises means for supporting at least one sensor device, the means for supporting having an inner surface and an outer surface; and means for absorbing one or both of shocks and vibrations, the means for absorbing coupled to the outer surface of the means for supporting.

### DRAWINGS

Embodiments of the present invention can be more easily understood and further advantages and uses thereof more readily apparent, when considered in view of the description of the preferred embodiments and the following figures in which:

FIGS. 1A and 1B are diagrams illustrating a disturbance isolation bracket of one embodiment of the present invention;

FIGS. 2A and 2B illustrate alternative embodiments of a device mount of embodiments of the present invention;

FIGS. 3A and 3B each illustrate a disturbance isolation bracket in combination with a housing of one embodiment of the present invention;

FIG. 4 illustrates a disturbance isolation bracket for accelerometer sensors of one embodiment of the present invention; and

FIG. 5 is a flow chart illustrating a method of one embodiment of the present invention.

In accordance with common practice, the various described features are not drawn to scale but are drawn to emphasize features relevant to the present invention. Reference characters denote like elements throughout figures and text.

### DETAILED DESCRIPTION

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the scope of the present invention. The following detailed description is, therefore, not to be taken in a limiting sense.

Embodiments of the present invention provide shock and vibration isolation to small sensors by constraining one or more sensors into a disturbance isolation bracket. Embodiments of the present invention comprise a ringed structure which provides an increased area for applying isolating elements with only a marginal increase in additional volume to accommodate tight spaces. Further, embodiments of the present invention provide an improved means for tuning the resonant frequency of sensors mounted to the disturbance isolation bracket of the present invention. Although examples of embodiments presented in this specification illustrate a circular disturbance isolation bracket, embodiments of the present invention are not limited to circular shapes. Instead, the bracket shape for embodiments of the present invention may be dictated by the housing in which the disturbance isolation bracket will be installed. In one embodiment, the bracket shape is one of, but not limited to, circular, elliptical, rectangular, triangular, and other poly-sided bracket shapes.

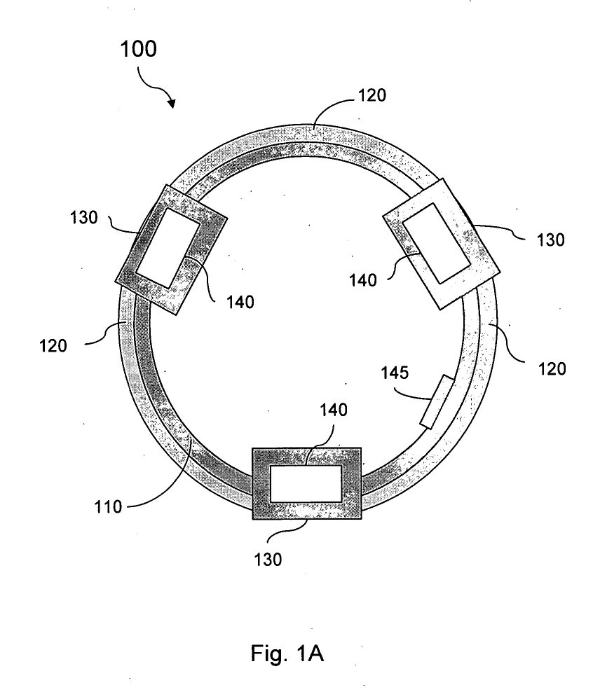

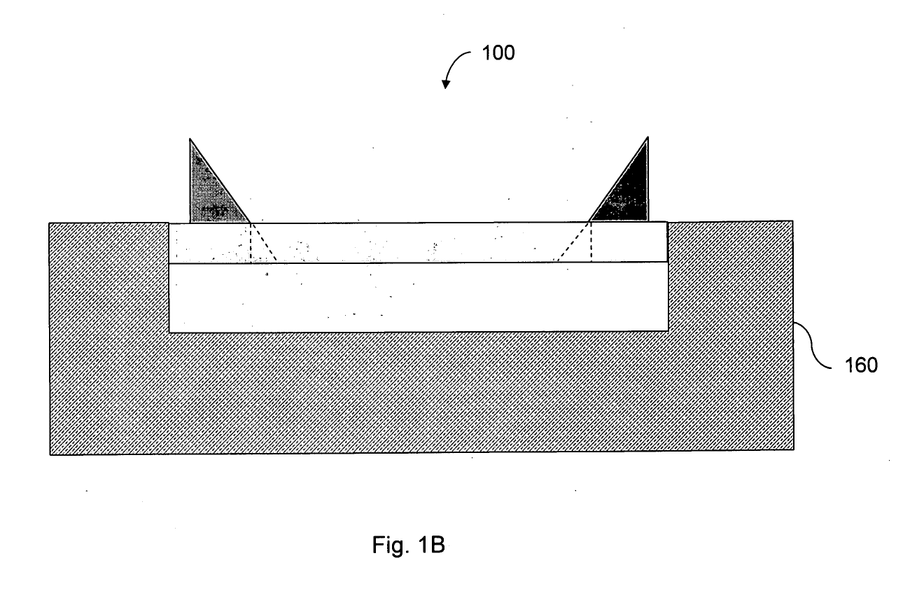

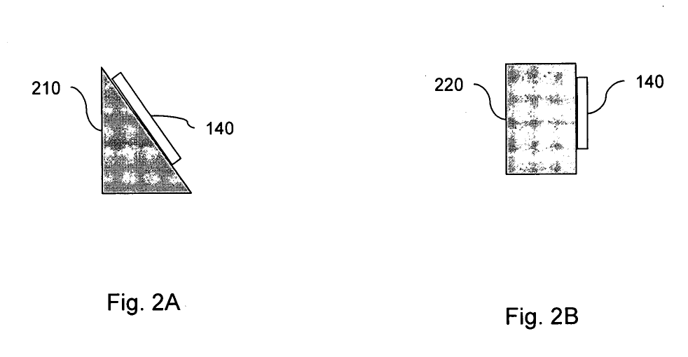

FIG. 1A illustrates a disturbance isolation bracket 100 of one embodiment of the present invention. In one embodiment, the disturbance isolation bracket 100 comprises a structural band 110 and at least one isolating element 120 coupled to an outer surface 115 of structural band 110. One or more device mounts 130, coupled to structural band 110, provide a surface for mounting one or more sensors 140. In one embodiment, a device mount 130 is either wedge shaped, such as device mount 210 illustrated in FIG. 2A, or rectangular, such as device mount 220 illustrated in FIG. 2B. In one embodiment, device mounts 130 are integrated into structural band 110. In one embodiment, the one or more sensors 140 include one or more of, but not limited to, temperature sensors and pressure sensors or other environmental sensors, and accelerometers or other inertial motion sensors.

As would be appreciated by one skilled in the art upon reading this specification, the exact disturbance absorbing material chosen to create isolating element 120 is determined based on the source and type of the dynamic disturbance causing the shock or vibration. The material is then chosen based on loads it will need to support, the dynamic operating conditions of its environment and the dynamic response of the material to the dynamic operating conditions (e.g. the natural frequency and dampening qualities of the material). In one embodiment, isolating element 120 is one of, but limited to, rubber, felt, and an elastomeric material such as, but not limited to a silicone material.

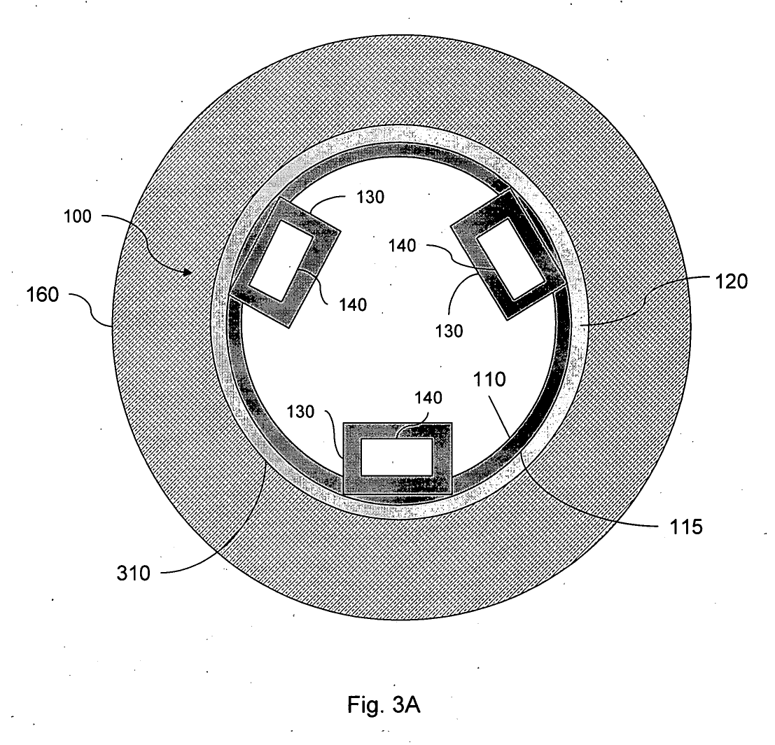

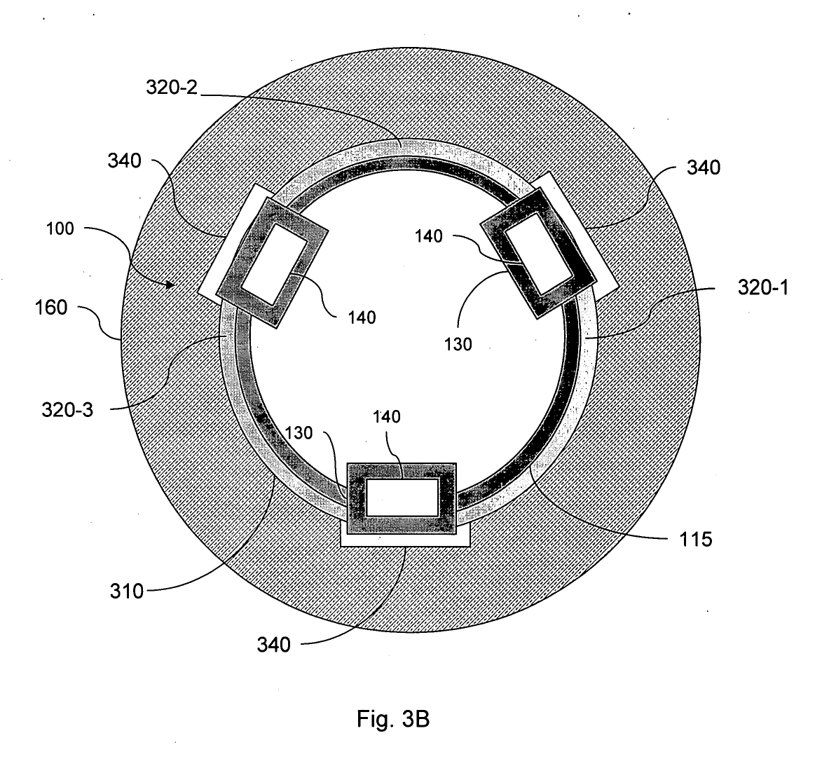

As illustrated in FIG. 1B, disturbance isolation bracket 100 is installed into a housing 160 within an end item, such as, but not limited to a missile or a spacecraft launch vehicle. As would be appreciated by one skilled in the art upon reading this specification, the effectiveness of isolating element 120 in reducing vibrations transmitted to sensors 140 increases when a greater quantity of the disturbance absorbing material is present at the interface between the source of the disturbance and the structure being protected. With embodiments of the present invention, the increased surface area of the interface (shown at 310 on FIG. 3A) between the disturbance isolation bracket 100 and housing 160 (relative to the interfacing surface of a sensor 140 direct mounted onto housing 160) allows the use of a greater amount of isolating element 120 material to insulate devices from vibration and shock energies. As a result, a disturbance isolation bracket 100 of embodiment of the present invention can be tuned to resonate at frequencies significantly lower than those possible with isolation systems having less interfacing surface area.

The resonant frequency of disturbance isolation bracket 100 of embodiments of the present invention can also be tuned by varying the weight of the structure. In one embodiment, the inclusion of one or more additional device mounts 130 and sensors 140 are used to vary the resonant frequency of disturbance isolation bracket 100. In one embodiment, one or more tuning weights 145 are coupled to structural band 110 to vary the resonant frequency of disturbance isolation bracket 100. In one embodiment, the material used to construct one or more of structural band 110 and device mounts 130 are chosen based on weight, to vary the resonant frequency of disturbance isolation bracket 100.

As illustrated in FIGS. 3A and 3B, in order to ensure that vibration and shock energies are not communicated to the one or more sensors 140, in one embodiment, isolating element 120 covers the entire surface of the interface 3 10 between the disturbance isolation bracket 100 and housing 160. Illustrated in FIG. 3A, in one embodiment isolating element 120 comprises a continuous ring of material between disturbance isolation bracket 100 and housing 160. In one embodiment, where the placement of device mounts 130 extends past outer surface 115 of structural band 110 (as shown in FIG. 3B), isolating element 120 comprises one or more non-continuous sections of material (illustrated as 320-1, 320-2 and 320-3) coupled to the outer surface 115 of structural band 110. In one embodiment, housing 160 further comprises one or more clearance voids 340, to isolate device mounts 130 from contacting housing 160.

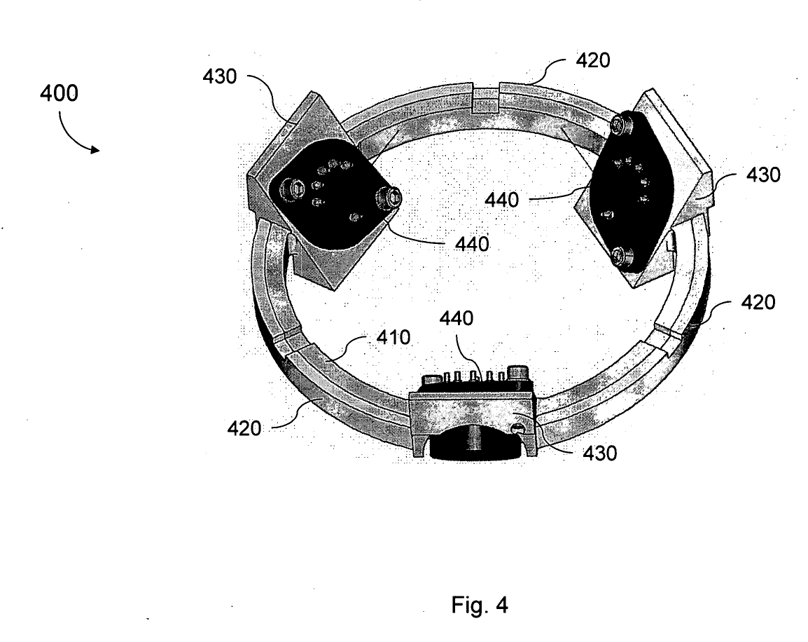

FIG. 4 illustrates a disturbance isolation bracket 400 for isolating a triad of accelerometer sensors 440. Typically in navigational applications, three accelerometer sensors 440 are mounted with an orthogonal orientation to each other. In one embodiment, accelerometer sensors 440 are Honeywell RBA 500 accelerometers: Disturbance isolation bracket 400 comprises a structural band 410 and at least one isolating element 420 coupled to structural band 410. One or more device mounts 430, coupled to structural band 410, provide a surface for mounting the triad of accelerometer sensors 440. In one embodiment, the geometric center of accelerometer sensors 440 and disturbance isolation bracket 400 are, ideally, as co-planar as possible. Because each accelerometer sensor 440 is secured to the same structural band 410, relative motion of the accelerometer sensors 440 with respect to each other is less than if each accelerometer sensors 440 was mounted using individual disturbance isolation systems, thus avoiding the performance degradation in accelerometer based navigation systems typically attributable to shock and vibration loading of the accelerometer sensors 440.

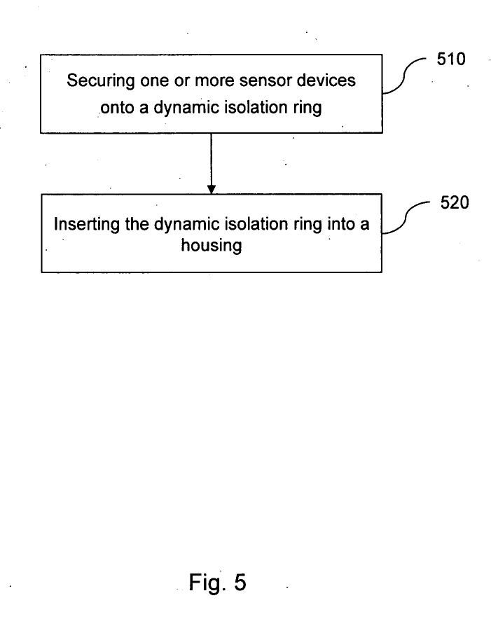

FIG. 5 is a flow chart illustrating a method for providing disturbance isolation for sensors of one embodiment of the present invention. The method begins at 5 10 with securing one or more sensor devices onto a disturbance isolation bracket having at least one isolating element. In one embodiment, the disturbance isolation bracket comprises a structural band and at least one isolating element couple to an outer surface of the structural band. In one embodiment, the band shape is one of, but not limited to, circular, elliptical, rectangular, triangular, and other poly-sided shapes. In one embodiment, the disturbance isolation bracket further comprises one or more device mounts coupled to the structural band, which provide a mounting surface on which to secure the one or more sensor devices. The method continues at 520 with inserting the disturbance isolation bracket into a housing located within an end item, such as, but not limited to a missile or a spacecraft launch vehicle. In order to ensure that vibration and shock energies are not transmitted to the sensor devices, the at least one isolating element covers the entirety of the interfacing surfaces between the disturbance isolation bracket and the housing. The resonant frequency of the disturbance isolation bracket is partially a function of the material selected for the at least one isolating element. The resonant frequency of the disturbance isolation bracket is also a function of its total mass. Therefore, in one embodiment, the method optionally further comprises adjusting a resonant frequency of the disturbance isolation bracket by securing one or more tuning weights to the disturbance isolation bracket.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

What is claimed is:

1. A disturbance isolation bracket, the bracket comprising:
a structural band having an inner surface and an outer surface;
at least one isolating element coupled to the outer surface of the structural band; and
at least one device mount coupled to the structural band and adapted to secure a sensor device to the structural band.

2. The bracket of claim 1, wherein the structural band further comprises one of a circular ring, an elliptical ring, and a poly-sided ring.

3. The bracket of claim 1, wherein the isolating element comprises an elastomer material.

4. The bracket of claim 1, further comprising:
one or more tuning weights coupled to the structural band.

5. The bracket of claim 1, further comprising:
wherein the at least one isolating element covers the entirety of one or more interfacing surfaces between the disturbance isolation bracket and a housing.

6. A sensor system, the system comprising:
one or more sensor devices;
a disturbance isolation bracket including a structural band having an inner surface and an outer surface, at least one isolating element coupled to the outer surface of the structural band, and one or more device mounts coupled to the structural band and adapted to secure the one or more sensor devices to the structural band; and
a housing adapted to accommodate insertion of disturbance isolation bracket.

7. The system of claim 6, wherein the at least one isolating element covers the entirety of one or more interfacing surfaces between the disturbance isolation bracket and the housing.

8. The system of claim 6, further comprising:
one or more tuning weights coupled to the structural band.

9. The system of claim 6, wherein the structural band further comprises one of a circular ring, an elliptical ring, and a poly-sided ring.

10. The system of claim 6, wherein the isolating element comprises one or more of an elastomeric material, a rubber material, and a felt material.

11. The system of claim 6 further comprising:
at least three accelerometer sensors;
wherein the at least one device mount includes at least three device mounts, wherein the at least three accelerometer sensors are secured to the structural band by the at least three device mounts, wherein the three accelerometers are each mounted with an orthogonal orientation to each other.

12. The system of claim 11 wherein a geometric center of the at least three accelerometers are approximately coplanar with a geometric center of the disturbance isolation bracket.

13. A method for isolating sensors from disturbances, the method comprising:
securing one or more sensor devices onto a disturbance isolation bracket comprising a structural band having an inner surface and an outer surface, the disturbance isolation bracket further comprising at least one isolating element coupled to the outer surface of the structural band; and
inserting the disturbance isolation bracket into a housing.

14. The method of claim 13 wherein inserting the disturbance isolation bracket comprises inserting the disturbance isolation bracket into a housing adapted to accommodate the disturbance isolation bracket.

15. The method of claim 13 wherein inserting the disturbance isolation bracket comprises inserting the disturbance isolation bracket into a housing adapted such that the at least one isolating element covers the entirety of one or more interfacing surfaces between the disturbance isolation bracket and the housing.

16. The method of claim 13, further comprising:
adjusting a resonant frequency of the disturbance isolation bracket by securing one or more tuning weights to the structural band.

17. A disturbance isolation bracket, the bracket comprising:
means for supporting at least one sensor device, the means for supporting having an inner surface and an outer surface; and
means for absorbing one or both of shocks and vibrations, the means for absorbing coupled to the outer surface of the means for supporting.

18. The bracket of claim 17, wherein the means for supporting at least one sensor device is adapted to support at least three accelerometer sensors, wherein the three accelerometers are each supported in an orthogonal orientation with respect to each other.

19. The bracket of claim 17, wherein the means for absorbing covers the entirety of one or more interfacing surfaces between the means for supporting and a means for housing the disturbance isolation bracket.

20. The bracket of claim 17 further comprising:
means for adjusting a resonant frequency of the disturbance isolation bracket.
